(19) United States
(12) Patent Application Publication
(10) Pub. No.: US 2009/0027871 A1
(43) Pub. Date: Jan. 29, 2009

(54) Display device for creating a backlit effect on a display article

(76) Inventor: Ajay Chadha, Tallahassee, FL (US)

Correspondence Address: Pennington, Moore, Wilkinson, Bell & Dunbar, P.A., 215 S. Monroe Street, 2d Floor, P.O. Box 10095, Tallahassee, FL, 32302-2095, US

(21) Appl. No.: 11/881,606

(22) Filed: Jul. 27, 2007

(51) Int. Cl. G01D 11/28

(52) U.S. Cl. 362/30

(57) ABSTRACT

A display device for creating a backlit effect on a display article—such as a photograph—with a candle. The display device includes a candle container and a display panel attached to the wall of the candle container by a spacer. The wall of the candle, display panel, and spacer together form a pocket for receiving the display article. Both the display panel and inner wall are clear to allow the light of the candle to transmit through the display device and create a backlit effect on the display article that is viewable through the display panel

### BACKGROUND OF THE INVENTION

1. Field of the Invention

This invention relates to the field of decorative candleholders and display devices. More specifically, the invention comprises a candle container configured to provide ambient backlighting for a user-selectable display article such as a picture.

2. Description of the Related Art

Various decorative candleholders that utilize a candle light source to illuminate a display article (such as a picture) are known in the prior art. Each of these prior art display devices use different illumination techniques to achieve a unique visual effect. Despite the existence of these types of devices there remains a need for a picture display device which is capable of imparting greater warmth and animation to a user-selected picture. It is also desirable for the device to be configured such that the user may easily change the picture displayed in the device from time to time. It is further desirable that such a display device be easy and cost-effective to manufacture and ship.

### BRIEF SUMMARY OF THE INVENTION

The present invention comprises a display device for creating a backlit effect on a display article—such as a photograph—with a candle. The display device includes a candle container and a display panel attached to the wall of the candle container by a spacer. The wall of the candle, display panel, and spacer together form a pocket for receiving the display article. Both the display panel and inner wall are clear to allow the light of the candle to transmit through the display device and create a backlit effect on the display article that is viewable through the display panel.

### BRIEF DESCRIPTION OF THE SEVERAL VIEWS OF THE DRAWINGS

FIG. 1 is a perspective view, showing the present invention.

FIG. 2 is a perspective view, showing the present invention with the display panel removed.

FIG. 3 is a perspective view, showing an alternate embodiment of the present invention.

FIG. 4 is a top view, showing the present invention.

FIG. 5 is a top view, showing an alternate embodiment of the present invention.

FIG. 6 is a perspective view, showing an alternate embodiment of the present invention.

FIG. 7 is a perspective view, showing an alternate embodiment of the present invention.

FIG. 8 is a top view, showing an alternate embodiment of the present invention.

FIG. 9 is a top view, showing an alternate embodiment of the present invention.

FIG. 10 is a perspective view, showing an alternate embodiment of the present invention.

REFERENCE NUMERALS IN THE DRAWINGS

| | | | |
|---|---|---|---|
| 10 | display device | 12 | candle container |
| 14 | display panel | 16 | spacer |
| 18 | spacer | 20 | spacer |
| 22 | inside wall | 24 | candle |
| 26 | pocket | 28 | wick |
| 30 | picture | 32 | mounting bores |
| 34 | mounting studs | 36 | spacer |
| 38 | spacer | 40 | picture |
| 42 | display panel | 44 | pocket |
| 46 | spacer | 48 | spacer |
| 50 | mounting bores | 52 | mounting studs |
| 54 | advertisement | 56 | wall |
| 58 | matrix | 60 | inner container |

### DETAILED DESCRIPTION OF THE INVENTION

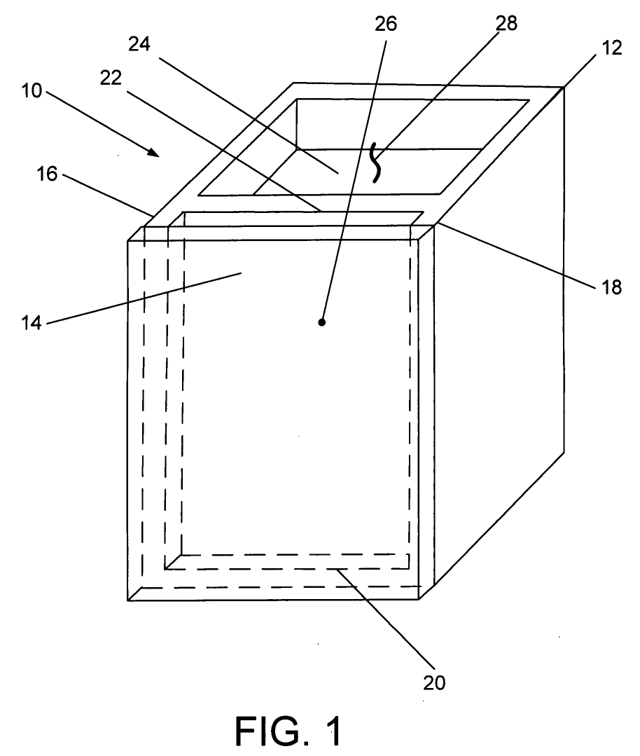

The present invention, display device 10, is illustrated in FIG. 1. Candle container 12 surrounds candle 24 which has wick 28. Candle 24 may be made of various hydrocarbon materials including waxes or gels. It is preferred that candle 24 be made of a clear material, however, as will be described in greater detail subsequently. In the current embodiment, candle 24 is a rectangular block of material, but candle 24 may assume many shapes. Candle container 12 is generally rectangular in shape (having a square cross-section) although candle container 12 may assume many different shapes. Spacers 16, 18, and 20 extend outwardly from a wall of candle container 12 annotated as inside wall 22. It is important that inside wall 22 be made of a clear or translucent material for reasons that will be explained in greater detail subsequently. Display panel 14, which is also made of a clear material such as glass, is attached to spacers 16, 18, and 20 to form pocket 26. The top of pocket 26 is open for receiving a display article such as a picture or photograph.

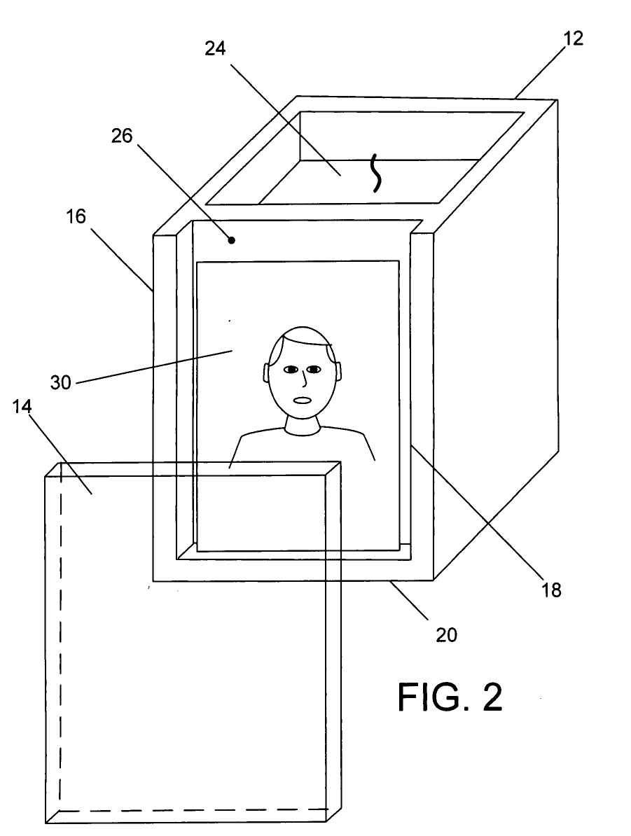

An exploded view of display device 10 is illustrated in FIG. 2. The reader will note that spacers 16, 18, and 20 are integrated with candle container 12. In the preferred embodiment, candle container 12 and spacers 16, 18, and 20 are made from a common piece of glass or clear plastic (such as polycarbonate). This optimizes the manufacturing process since attaching spacers 16, 18, and 20 to candle container 12 with adhesive or mechanical fasteners adds another stage and potential bottleneck in the manufacturing process. Display panel 14 is a separate component which is attached to spacers 16, 18, and 20 later in the manufacturing process. In the present embodiment, display panel 14 is attached to spacers 16, 18, and 20 by a contact adhesive such as a glue or epoxy. FIG. 2 also illustrates how picture 30 rests on spacer 20 when placed in pocket 26.

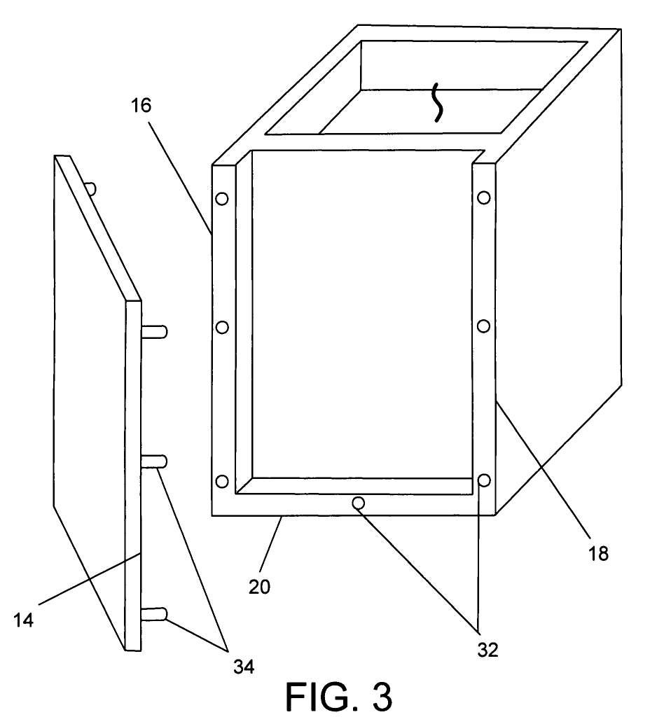

FIG. 3 illustrates an alternate embodiment of the present invention. In this embodiment, spacers 16, 18, and 20 have mounting bores 32 which are blind holes bored into the spacers. Mounting bores 32 are sized to receive mounting studs 34 which are attached to display panel 14. Other mechanical fasteners such as screws or rivets may also be used to attach display panel to spacers 16, 18, and 20. Contact adhesive may be used in addition to the mechanical fasteners. For example, contact adhesive may be injected into mounting bores 32 to prevent display panel from separating from the candle container.

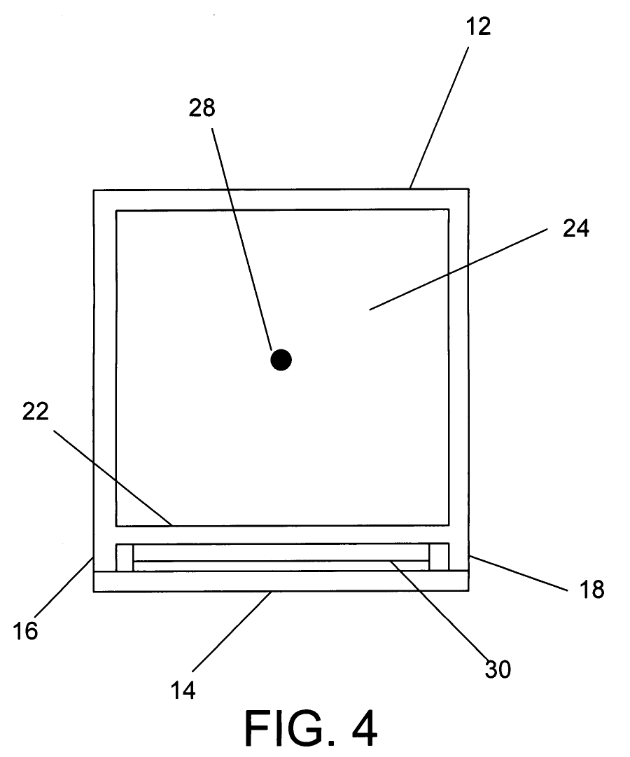

A top view of candle container 12 is provided in FIG. 4. The reader will note that picture 30 rests between display panel 14 and inside wall 22. When wick 28 is lighted, candle light passes through inside wall 22 and strikes the back of picture 30. This creates a backlit effect on the picture. The term “backlit effect” as used herein means any effect created on a display article when light from a light source strikes the display article on one side and the display article is viewed from the opposite side. The natural flickering and the orange light emitted by the burning candle, makes skin tones in photographs appear more lifelike and pictures appear more aesthetically pleasing. In the present embodiment, it is desirable for candle 24 to be made of a clear material so that candlelight can pass through candle 24 and inside wall 22.

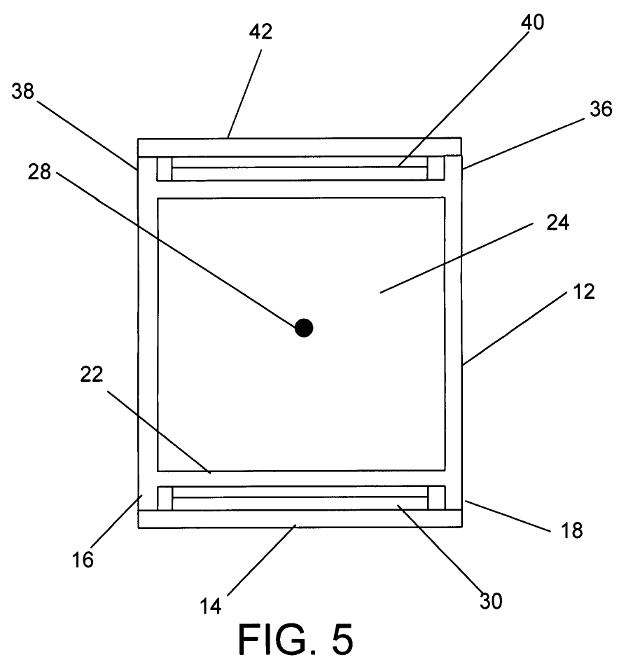

An alternate embodiment of the present invention is illustrated in FIG. 5. In this embodiment, display panels are provided on both sides of candle container 12 to allow multiple display articles to be shown. Spacers 36 and 38 extend away from candle container 12 on the side of candle container 12 opposite of spacers 16 and 18. Display panel 42 is attached to spacers 36 and 38. Picture 40 is then inserted into the pocket formed by candle container 12, spacers 36 and 38, and display panel 42.

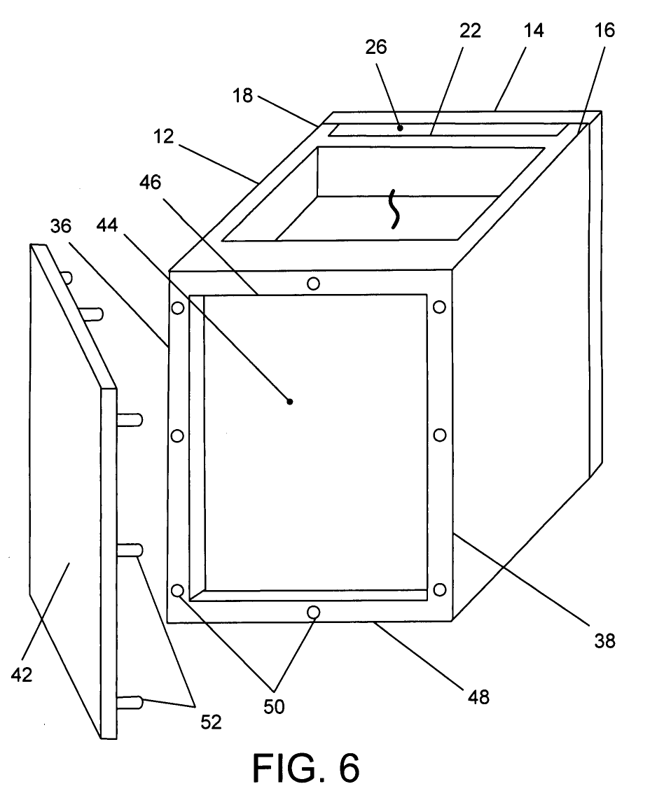

As illustrated in FIG. 6, the second display article may be entirely enclosed and sealed in the pocket to prevent removal. To accomplish this, spacers 36, 38, 46, and 48 surround and completely encompass pocket 44. Mounting bores 50 are provided in the spacers for receiving mounting studs 52 of display panel 42.

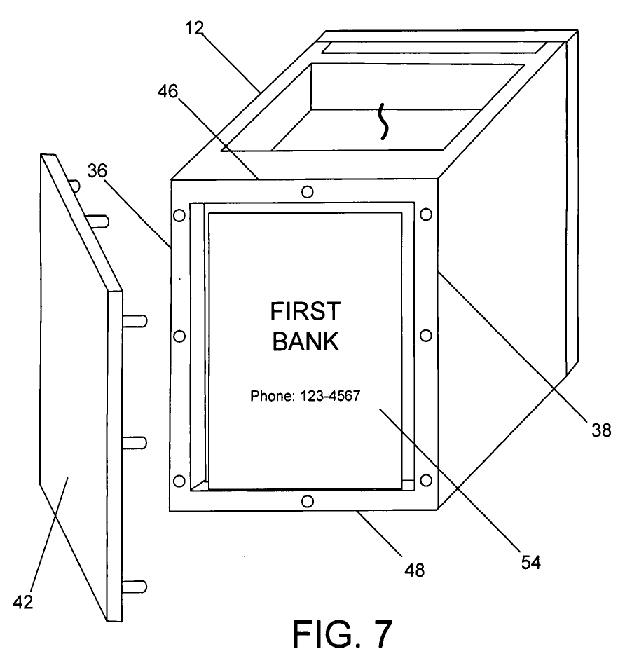

Turning to FIG. 7, advertisement 54 is placed between spacers 36, 38, 46, and 48 and is then enclosed in the pocket with the attachment of display panel 42 to the spacers. As such, the display device may be provided to customers of a business as a promotional item or gift. The customer may use the unsealed pocket for a photograph of his or her choice, and advertisement 54 will thereafter be displayed in the customer's home or office.

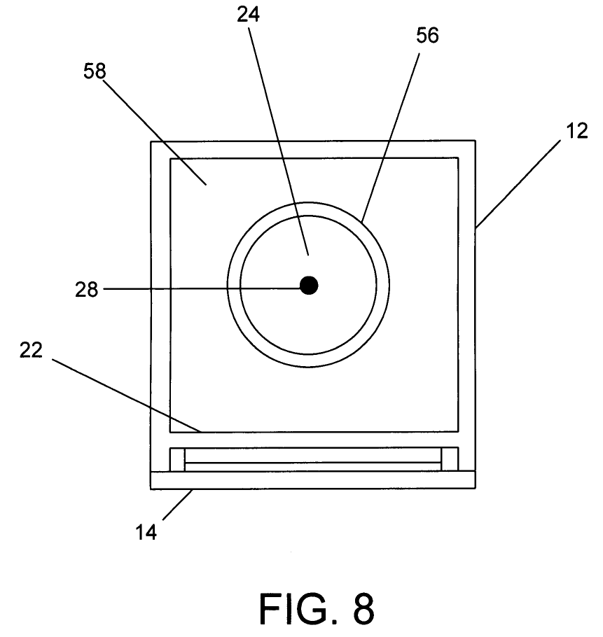

As shown in FIG. 8, the display device may be further improved by providing wall 56 within candle container 12 to separate candle 24 from matrix 58. Wall 56 is a clear vertical cylinder. It may be made of glass, polycarbonate or other material capable of withstanding the heat produced when burning candle 24. Matrix 58 is preferably a clear gel that dispenses a volatile fragrance when candle 24 is lit. Matrix 58 may also contain decorative objects such as flower petals, colored glass or beads.

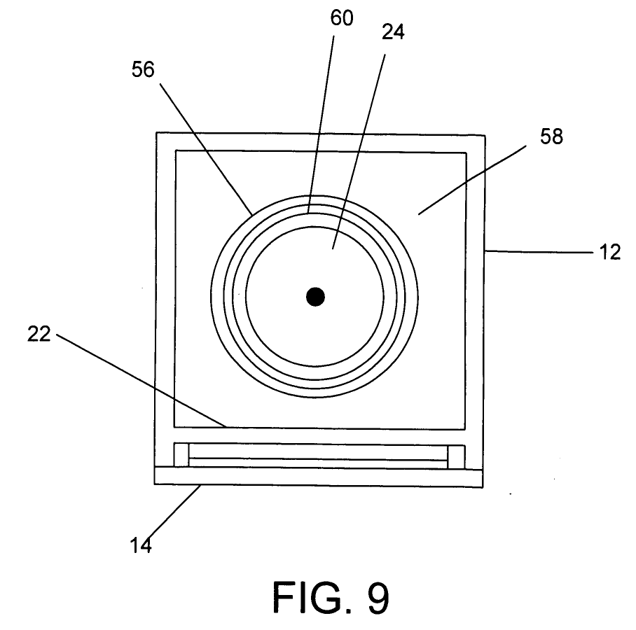

As a further improvement of the embodiment of FIG. 8, candle 24 may be provided in inner container 60 to allow for easy replacement when candle 24 is completely consumed as shown in FIG. 9. If inner container 60 is not used, residue from candle 24 would remain within wall 56 after candle 24 is consumed. In such a case, the residue must be scraped out of the region enclosed by wall 56 before a replacement candle is placed within wall 56. However, using the embodiment of FIG. 9, inner container 60 may be easily removed from candle container 12 and a replacement candle and container may be inserted in its place. This allows the display device to be used even after the original candle is completely consumed.

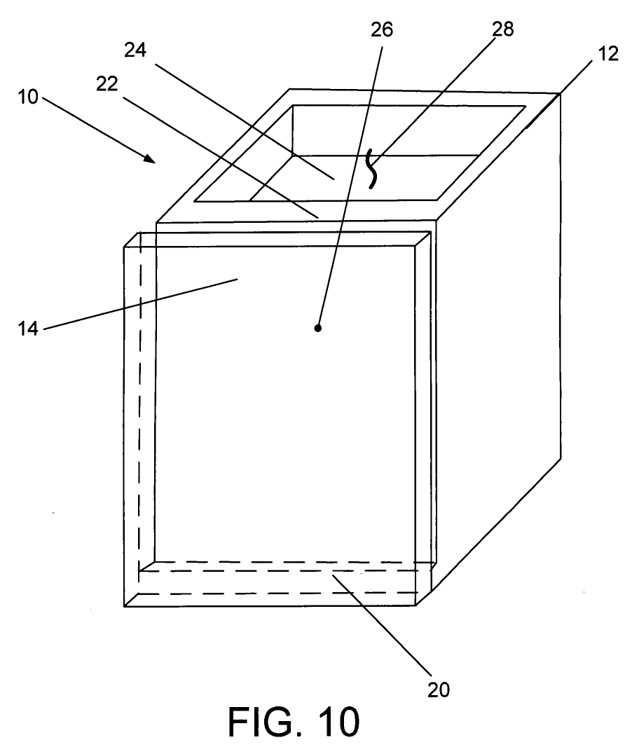

The preceding description contains significant detail regarding the novel aspects of the present invention. It is should not be construed, however, as limiting the scope of the invention but rather as providing illustrations of the preferred embodiments of the invention. For example, candle container 12 may assume various angular or curvilinear cross-sectional shapes. Candle container 12 need not have a cross-section in the shape of a square. In addition, as illustrated in FIG. 10, pocket 26 may be formed with single spacer 20, inside wall 22, and display panel 24, thus eliminating the spacers on the sides of the pocket. The scope of the invention should therefore be fixed by the following claims, rather than by the examples given.

1. A display device comprising:
a. a candle, said candle having a wick;
b. a container, said container surrounding said candle, said container having a first clear wall;
c. a first clear display panel, said first display panel attached to said first wall of said container;
d. a first spacer, said first spacer attached to said first display panel and said first wall of said container;
e. a first air-filled pocket, formed by said first spacer, said first wall of said container, and said first display panel, said first air-filled pocket forming a cuboid bounded by a first face, a second face, a third face, a fourth face, a fifth face, and a sixth face; said first face, said second face, and said third face each lying on said first spacer, said fourth face lying on said first clear wall of said container, said fifth face lying on said first clear display panel, and said sixth face bounded by said first clear display panel, said first wall of said container and said spacer; said air-filled pocket fluidly sealed along the entirety of said first face, said second face, said third face, said fourth face, and said fifth face of said cuboid by said first spacer, said first clear display panel, and said first wall of said container; and
f. a display article, said display article having a first side and a second side, said display article positioned in said first pocket such that said first side faces said first wall and said second side faces said first display panel, said display article further positioned such that when said candle is lit, candlelight passes through said first clear wall, strikes said first side of said display article thereby creating a backlit effect on said display article which is viewable through said first display panel.

2. The display device of claim 1, wherein said candle comprises a clear material.

3. The display device of claim 1, wherein said container includes a second clear wall, said display device further comprising:
a. a second clear display panel, said second display panel attached to said second wall of said container;
b. a second spacer, said second spacer attached to said second display panel and said second wall of said container;
c. a second air-filled pocket, formed by said second spacer, said second wall of said container, and said second display panel; and
d. a second display article, said second display article having a first side and a second side, said second display article positioned in said second pocket such that said first side faces said second wall and said second side faces said second display panel, said second display article further positioned to be viewable through said second display panel.

4. The display device of claim 1, said candle container containing a clear gel matrix.

5. The display device of claim 1, wherein said first display panel is bonded to said first spacer with a contact adhesive.

6. The display device of claim 1, wherein said first display panel is attached to said first spacer by a mechanical fastener.

7. The display device of claim 3, wherein said second display article is sealed and completely enclosed in said second pocket.

8. The display device of claim 1, further comprising a second spacer attached to said first display panel and said first wall of said container, said second spacer perpendicularly situated with respect to said first spacer.

9. The display device of claim 4, further comprising an inner wall within said container, said inner wall separating said candle from said clear gel matrix.

10. The display device of claim 9, further comprising an inner container surrounding said candle, said inner container situated within said inner wall.

11. The display device of claim 1, wherein said display article is a photograph.

12. The display device of claim 3, wherein said second display article is a business advertisement.

13. A display device for creating a backlit effect on a display article, said display article having a front side and a back side, said display device comprising:
a. a candle, said candle having a wick;
b. a container, said container surrounding said candle, said container having a first clear wall;
c. a first clear display panel, said first display panel attached to said first wall of said container;
d. a first spacer, said first spacer attached to said first display panel and said first wall of said container;
e. a first air-filled pocket, formed by said first spacer, said first wall of said container, and said first display panel, said first air-filled pocket forming a cuboid bounded by a first face, a second face, a third face, a fourth face, a fifth face, and a sixth face; said first face, said second face, and said third face each lying on said first spacer, said fourth face lying on said first clear wall of said container, said fifth face lying on said first clear display panel, and said sixth face bounded by said first clear display panel, said first wall of said container and said spacer; said air-filled pocket fluidly sealed along the entirety of said first face, said second face, said third face, said fourth face, and said fifth face of said cuboid by said first spacer, said first clear display panel, and said first wall of said container; and
f. wherein said display device is configured to create a backlit effect on said display article when said display article is positioned in said first pocket such that said back side faces said first wall and said front side faces said first display panel and said candle is lit, such that candlelight passes through said first clear wall, strikes said back side of said display article thereby producing said backlit effect which is viewable through said first display panel.

14. The display device of claim 13, wherein said candle comprises a clear material.

15. The display device of claim 13, wherein said container includes a second clear wall, said display device further comprising:
a. a second clear display panel, said second display panel attached to said second wall of said container;
b. a second spacer, said second spacer attached to said second display panel and said second wall of said container;
c. a second air-filled pocket, formed by said second spacer, said second wall of said container, and said second display panel; and
d. a second display article, said second display article having a first side and a second side, said second display article positioned in said second pocket such that said first side faces said second wall and said second side faces said second display panel, said second display article further positioned to be viewable through said second display panel.

16. The display device of claim 13, said candle container containing a clear gel matrix.

17. The display device of claim 13, wherein said first display panel is bonded to said first spacer with a contact adhesive.

18. The display device of claim 13, wherein said first display panel is attached to said first spacer by a mechanical fastener.

19. The display device of claim 15, wherein said second display article is sealed and completely enclosed in said second pocket.

20. The display device of claim 13, further comprising a second spacer attached to said first display panel and said first wall of said container, said second spacer perpendicularly situated with respect to said first spacer.

21. The display device of claim 16, further comprising an inner wall within said container, said inner wall separating said candle from said clear gel matrix.

22. The display device of claim 21, further comprising an inner container surrounding said candle, said inner container situated within said inner wall.

23. The display device of claim 13, wherein said display article is a photograph.

24. The display device of claim 15, wherein said second display article is a business advertisement.
